(19) United States
(12) Patent Application Publication
(10) Pub. No.: US 2006/0201346 A1
(43) Pub. Date: Sep. 14, 2006

(54) Recovery plant of fibers and substances to the tomato-peel

(76) Inventors: Milser Borchini, Varano De'Melegari (Parma) (IT); Carla Alfieri, Varano De'Melegari (Parma) (IT); David Borchini, Varano De'Melegari (Parma) (IT); Denis Borchini, Varano De'Melegari (Parma) (IT); Damarys Borchini, Varano De'Melegari (Parma) (IT)

Correspondence Address: YOUNG & THOMPSON, 745 SOUTH 23RD STREET, 2ND FLOOR, ARLINGTON, VA, 22202, US

(21) Appl. No.: 10/566,257

(22) PCT Filed: Jul. 29, 2004
(86) PCT No.: PCT/IB04/02426

§ 371 Date: Jan. 30, 2006

(30) Foreign Application Priority Data
Aug. 4, 2003 (EP) 03425533.1

(51) Int. Cl. B30B 9/24

(52) U.S. Cl. 100/118

(57) ABSTRACT

The plant consists of an Archimedes screw in where the water arrives and into which arrive the working waste such us tomato-peel, seeds, molds and impurities that then gravitationally arrive into a cyclone with water where a first separation is actuated such as the tomato-peels float and stay on the surface whereas the other waster precipitate on the bottom. Actuated the peel/water separation, through a separation filter said peels arrive to a second separation filter, to a slanting collecting line and to a compacting device. Then the peels arrive to a collecting tank where are mixed with the juice of the tomato to arrive then, peels and juice, to a first disintegrator device, to a second disintegrator device, to a collecting tank to a transfering pump and at the end to a de-aerator that, eliminated air, sends the product to the homogenizer and at the end to a concentrator.

### TECHNICAL FIELD

In the plants working the products with a basis of tomato the working waste, consist of seeds, impurities and tomato-peel, are normally discarded. In the working cycle, considering the period of twenty-four hours, this working waste forms the 3% of the working product total mass. Of this percentage the 1.5% represents the seeds and impurities such as molds, dirtiness and other residuals, while the other 1.5% is formed to the tomato-peel.

### BACKGROUND ART

Apparatuses are known that actuate the recovery of the working waste in their whole, i.e. without actuating the separation of these two types of working waste so having a final product of poor quality. The invention refers to a new working plant able to separate these two working waste and able to regenerate the valuable part: the outside part of the tomato, i.e. the part that forms the peel normally known as tomato-peel. Said peel infact is made to important substances from the nutritional point of view. It is infact made to lycopene, very important substance active against the free radicals, carotene, substance with vitaminic content and acting like natural dye of the final product and fiber the importance of which in the nourishment is well-known. Moreover the invented plant permits to separate and to eliminate to the final product the seeds, the molds and the impurities. The seeds, contained in the final product, are infact noxious for the conservation process, they are indigestible for the organism and, stanching inside the intestine, irritate the same, while the molds and the impurities, present in the final product, are to be absolutely to avoid for hygienic reasons and for the product conservation. Moreover, the invented plant has an economic return of the necessary investment necessary to actuate the production line such as the material cyclic recovery, that normally is eliminated, permits to pay in time the cost of the same plant and come to determine a final product, at the end of the working cycle, with better quality in comparison with the present product because comes to recover important substances from the tomato.

### DISCLOSURE OF INVENTION

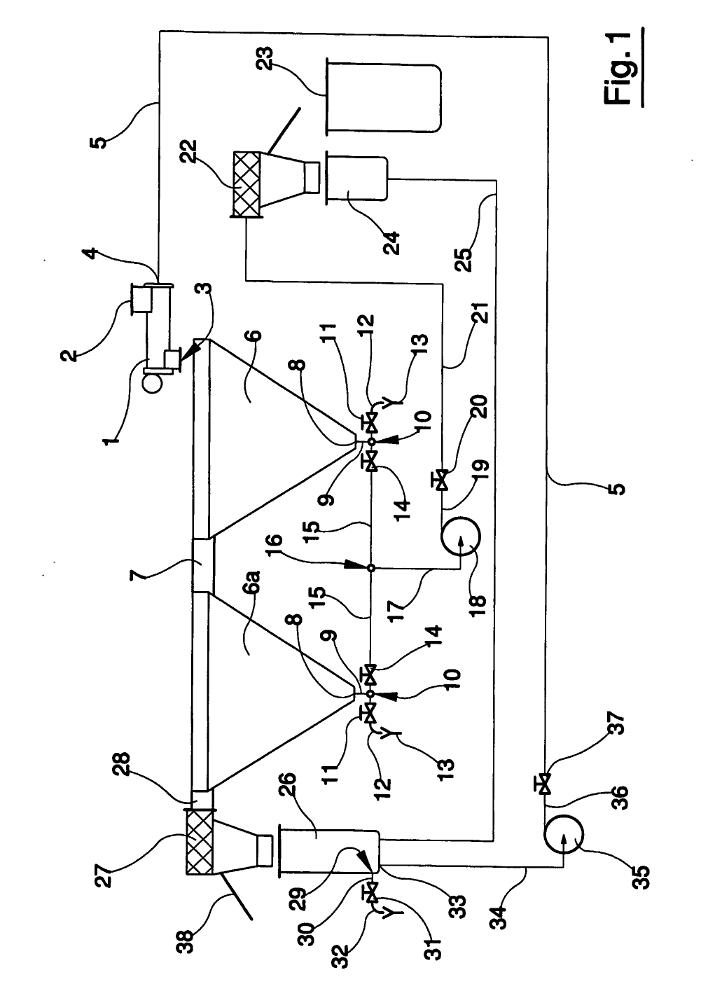

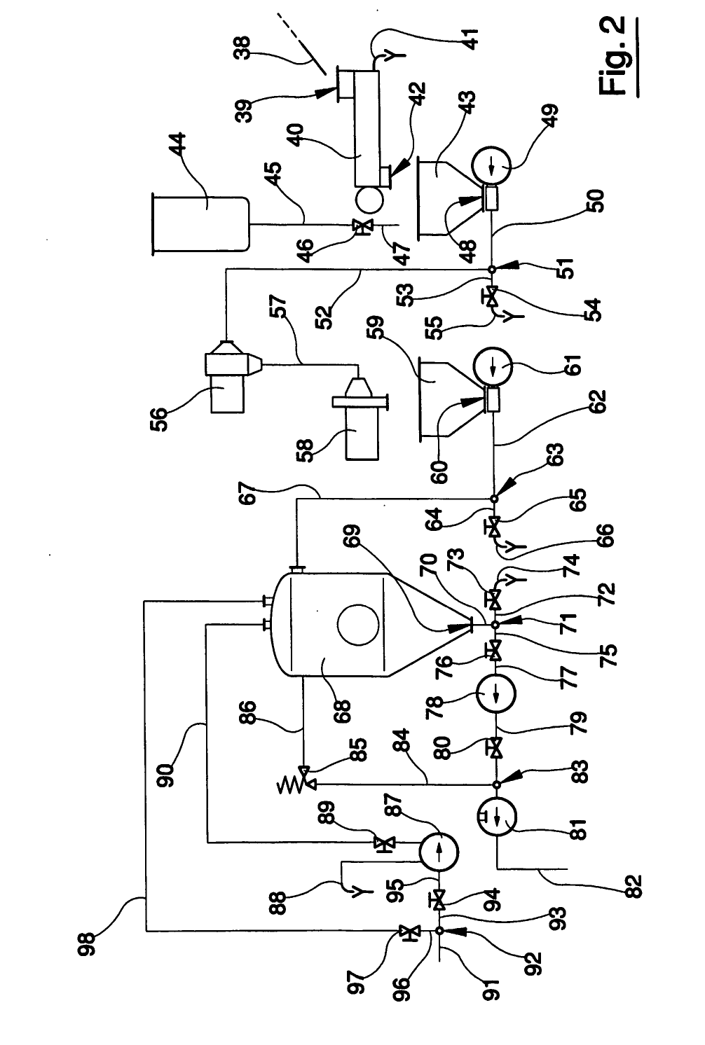

The plant provides an Archimedes screw 1 in where are coming the working waste in their whole, i.e. tomato-peel, seeds, molds and impurities. Said working waste come inside said Archimedes screw from the upper inlet 2 and then go out from the lower outlet 3. The Archirmedes screw 1 is equipped with hole 4 with pipe 5 for water inlet coming from a closed circuit. The lower outlet 3 is placed on the upper part of a cyclone 6. In this cyclone, i.e. a big dimension conical container with water in its inside, arrive the working waste for gravitational fall to the Archimedes screw 1. The working waste are so, in this first phase, separated each other such as the tomato-peels float and stay on the surface, whereas the molds, the impurities and the seeds precipitate on the bottom. The cyclone 6 so has the work to separate two different kinds of working waste. Said cyclone 6 has primary importance in the separation of the two types of working waste and its dimension are in relation to the quantity of product to work. The dimensions, or alternatively the number of the cyclones present on the line production, change consequently on the base of the quantity of product to work. In an executive embodiment for a medium work a second cyclone 6A is provided, also it full of water and connected with the first cyclone 6 by a duct 7 which connects the superficial water of the two cyclones with the tomato-peels. In the lower part the cyclones 6 and 6A are equipped with an opening 8 with collecting water pipe line 9. With this pipe line is outwardly connected by means of T pipes 10 hand drive valve 11 with flow line 12 to the opened drains 13. The pipe line with T pipes 10 is connected to the other end, internally, to the hand drive valves 14 connected each other with the flow line 15. In central position 20 is placed the T connection 16 with lower pipe 17 connected to the centrifugal pump 18. The exit of the centrifugal pump 18 is connected, by pipe 19, to the hand drive valve 20. The exit of said valve is connected, by pipe 21, to a separation filter 22. Said filter, by an inside roll riddle, acts to separate the water from the seeds and the impurities that go into a collecting tank 23, whereas the water is recovered into a container 24 and, by a pipe 25, is brought inside a liquid collecting tank 26. Said tank 26 has the function to contain and to redistribute the recovered water during the working. In this tank also the water coming from the separation filter 27 arrives. This filter, equal to the separation filter 22, is placed near the upper part of the cyclone 6A, connected with it by a channel 28 and, having like the previous filter an inside roll riddle, provides to separate the tomato-peels from the water. The action of the roll riddle moreover creates a dragging motion so to generate a superficial running of the upper water contained inside the cyclones so to drive the tomato-peels toward the filter 27. Inside this filter the separation between tomato-peels and water is actuated. The water comes gravitationally to fall inside the collecting tank 26. Said tank equipped with a weep hole 29 with pipe 30 and hand drive valve 31 connected to the opened drain 32. The hand drive valve 31 is usually closed when the plant is working and it is opened for maintenance or for discharging of the water contained inside the tank 26. The tank 26 provides another lower opening 33 connected with pipe 34 to the centrifugal pump 35. This pump, with pipe 36 and hand drive valve 37, is connected to the pipe 5. It is so realized a closed circuit of water recycling. It is obtained a reuse of the water from the tank 26, delivered by the pipes 34, 36 and 5 and by the centrifugal pump 35, to the Archimedes screw 1 so to limit the costs of plant operating. The tomato-peels, coming from the separator filter 27, separated to the water, arrives on the slanting collecting line 38 to fall into the upper opening 39 of a compacting device 40. Inside this device the tomato-peels are compressed and separated to the residual water eventually present. The residual water is discharged through the opened drain 41. The compacting device 40 has an outlet 42 to which is placed a collecting tank 43. In this tank arrives, to a tank 44 with pipe 45, hand drive valve 46 and pipe 47 the juice of the tomato. The juice of the tomato so arrives inside the tank 43 where the compressed tomato-peels are present. The juice of the tomato is added in quantity of 10% in comparison with the total mass of the tomato-peels. The tomato-peels and the juice of tomato go out to the lower opening 48 of the container 43 to be pushed by the removal pump 49 to the pipe 50. Said pipe is connected with the T connection 51 with other ends of the pipes 52 and 53. This last pipe 53 is connected with the hand drive valve 54 and with the opened drain 55. Such as the hand drive valve 54 is usally closed, the flow formed to the tomato-peels and the juice of tomato goes on through the pipe 52 to reach a first disintegrator device 56. In this first disintegrator device the product coming to the pipe 52 is broken up into small pieces till about two millimetres of medium diameter. The flow of tomato-peels and juice of tomato arrives, through a pipe 57, to a second disintegrator device 58 where is broken more fine so to have an inside medium diameter that changes to 150 to 300 micron. This working phase, so the subsequent phases, are necessary to avoid the separation between liquids and solids that will happen at the final product and so to make extremely digestibile the fiber contents. The broken juice and peel of tomato arrive, for gravitationally falling, inside the collecting tank 59 for then passing, through the lower opening 60, to the transfering pump 61. The flow arrives then to the pipe 62 connected with a T pipe 63. An end of this T pipe is connected to a pipe 64, to a hand drive valve 65 and to the opened drain 66. The other T pipe 63 end is connected to the pipe 67. Such as said valve is usually closed, the product flow goes on, through the pipe 67 to the de-aerator 68. This device acts to suck the air contained in the peel and in the juice of tomato. The de-aerator 68 is lower provided with an opening 69 and pipe 70 with T pipe 71. Said T pipe on one end is connected with pipe 72, hand drive valve 73 and opened drain 74, whereas on the other end is equipped with pipe 75, hand drive valve 76, other pipe 77 and product vacuum pump 78. Said pump sends the flow of juice and peel tomato, through pipe 79 and hand drive valve 80, to the homogenizer 81. At the exit of said homogenizer 81 a product is obtained where is not possible the separation of the liquids and of the solids that are part of the product. The so obtained product is brought, by means of the pipe 82, to the production line to reach a concentrator. In the case of no function of the homogenizer 81 is provided onto the pipe 79 a T pipe 83 that creates the connection to an other pipe 84. This last one is connected to an angle safety valve 85 also connected with the other end to the de-aerator 68. These components connected each other are necessary to realize a recycling or return branch so to permit the return of the product inside the de-aerator 68. Moreover, for the correct vorking of the de-aerator, is necessary the vacuum pump 87 connected with the drain 88, with a valve 89 and with a pipe 90 of connection to the de-aerator. To provide to the washing of the de-aerator 68 is provided a pipe connected with the water supply 91 with T pipe 92 having an end connected to a pipe 93 and hand drive valve 94 connected, by means of pipe 95, to the vacuum pump 87. The other end of the T pipe 92 is connected with pipe 96 to the hand drive valve 97 and from this to the pipe 98. The pipe 98 is consequently connected to the de-aerator 68. Making to come water from the pipe 91 and having the valve 94 closed and the valve 97 opened, the washing of the de-aerator 68 and of the other parts is actuated. Having instead the valve 97 closed and the valve 94 opened is feeding the vacuum pump. The invented plant is illustrated in a schematic and indicative way in the drawings of sheets 1 and 2. In sheet 1 FIG. 1 is view of the first part of the plant till the slanting collecting line 38. In sheet 2 FIG. 2 is view of the second part of the plant.

1) Recovery plant of fibers and substances to the tomato-peel providing an Archimedes screw (1) in where come, to an upper inlet (2), the working waste such as tomato-peels, seeds, molds and impurities for then going out from a lower outlet (3) and where said Archimedcs screw (1) is equipped with hole (4) with pipe (5) for water inlet; characterized in that:
the working waste from the lower inlet (3) gravitationally arrive to a cyclone (6) with water where a first separation is actuated such as the tomato-peels float and stay on the surface whereas the molds, the impurities and the seeds precipitate on the bottom and through an opening (8), pipe lines and hand drive valves come to a separation filter (22) and, separated from the water, arrive into a collecting tank (23); and that
the floating tomato-peels arrive to a separation filter (27), placed in the upper part of the cyclone (6), which separates the peels from the water and send these peels onto a slanting collecting line (38) which determirnes their falling into a compacting device (40), and that
said compacting device (40) separates the peels to the residual water and, through an outlet (42), discharges the same inside a collecting tank (43) where comes, by a pipe and hand drive valve, the juice of tomato; and that
tomato-peels and juice of tomato, through a lower opening (48) and by means of a removal pump (49), arrive in different pipes to reach a first disintegrator device (56), where a first disintegration is actuated, and a second disintegration device (58), where a second disintegration is made for then gravitationally falling inside a collecting tank (59) and then passing to a transferring pump (61); and that
through pipes and valves the flow of juice and peel of tomato arrives to a de-aerator (68) with a lower opening (69) from which the flow, by means of a vacuum pump (78), is sent to a homogenizer (81); and that
the homogenized product is sent, through a pipe (82), to the production line to reach a concentrator.

2) Recovery plant of fibers and substances to the tomato-peel, according to the claim 1, characterized in that the cyclone (6) is dimensioned in relation to the quantity of product to work and so its dimensions or the number of cyclones (6) change of the base of the quantity of product to work.

3) Recovery plant of fibers and substances to the tomato-peel, as per claim 1, characterized in that the water discharged in the different phases arrives to a collecting tank (26) with a lower opening (33) and connects through a pipe (34) to a centrifugal pump (35) connects to the pipe 5 of water inlet so to realize a water recycling during the works.

4) Recovery plant of fibers and substances to the tomato-peel, as per claim 1, characterized in that in the first desintegrator device (56) the peel/juice product is broken up into small pieces till about two millimetres of medium diameter. while the second disintegrator device (58) actuates a frantumation to have a medium diameter that changes to 150 to 300 micron.

5) Recovery plant of fibers and substances to the tomato-peel, as per claim 1, characterized in that at the exit of the homogenizer (81) a product is obtained where is not possible the separation of the liquids and of the solid part of the product.
